(19) United States
(12) Patent Application Publication
(10) Pub. No.: US 2019/0003857 A1
(43) Pub. Date: Jan. 3, 2019

(54) SENSOR AND SENSOR ELEMENT

(71) Applicant: MICRO-EPSILON MESSTECHNIK GMBH & CO. KG, Ortenburg (DE)

(72) Inventors: Josef HACKL, Passau (DE); Axel SEIKOWSKY, Ortenburg (DE); Martin WASMEIER, Ortenburg (DE)

(73) Assignee: Micro-Epsilon Messtechnik GmbH & Co., KG, Ortenburg (DE)

(21) Appl. No.: 15/755,461

(22) PCT Filed: Feb. 9, 2017
(86) PCT No.: PCT/DE2017/200016

§ 371 Date: Feb. 26, 2018

(30) Foreign Application Priority Data
Feb. 19, 2016 (DE) 10 2016 202 637.2

(51) Int. Cl. G01D 5/20; G01D 5/24; G01D 11/04

(52) U.S. Cl. CPC G01D 5/2006; G01D 11/04; G01D 5/24

(57) ABSTRACT

A non-contact working sensor, especially an inductive or capacitive sensor, preferably for measuring the distance or position of an object, with an inductive or capacitive sensor element, wherein measuring elements of the sensor element are embedded in a multilayered ceramic and together with the ceramic form the sensor element, is characterized in that the sensor element is constructed geometrically and/or electrically symmetrical in regard to its measuring elements and in that a mounting spaced apart from a holder is realized with the least possible contact surfaces on the sensor element. Furthermore, the invention relates to a sensor element, such as is used in the sensor according to the invention.

The invention relates to a non-contact working sensor, especially an inductive or capacitive sensor, preferably for measuring the distance or position of an object, with an inductive or capacitive sensor element, wherein measuring elements of the sensor element are embedded in a multilayered substrate and together with the substrate form the sensor element. Furthermore, the invention relates to a sensor element, such as is used in the sensor according to the invention.

For the detecting of distance, displacement, position and similar measured quantities, noncontact measurement methods are also used preferably in industry alongside tactile measurement methods, in order to avoid an unwanted interaction (on the one hand, wear on the measurement device, on the other hand influence on the measurement object) between the measurement device and the measurement object. Field-bound sensors are an often used category of such sensors. Thanks to a suitable arrangement, an analogy is achieved between the change in the electric or magnetic field and the change in displacement, position, or distance.

Examples of such sensors are capacitive displacement transducers, or inductive displacement transducers in general, such as eddy current displacement transducers, or also transformer-based principles, such as inductive displacement transducers working by the LVDT principle or coil arrangements whose magnetic coupling changes relative to each other through the relative spacing. In order to keep as low as possible the influence of perturbing factors, which falsify the analogy between change in field and change in displacement, such measurement systems often have a differential design. The most simple example of this is a half-bridge arrangement, in which two identical measuring elements are electrically interconnected in two branches of a Wheatstone bridge circuit so that perturbing factors cancel each other out. In this way, perturbing factors such as temperature changes can be suppressed. In practice, however, this is only possible in limited fashion, since the principle of differential signal evaluation only suppresses the perturbing factors when they are acting equally on both partial pathways.

However, in the case of temperature changes gradients occur not only over time, but also over location. These are not equalized by the differential arrangement. An example of this is inductive distance sensors, whose measuring elements (coils) are installed in a housing. One coil arranged for example at the end face is oriented toward the measurement object and measures its distance dynamically, a second coil in the housing measures statically against a reference object in the housing. In a half-bridge arrangement, an electrically symmetrical arrangement of the measuring elements can be achieved. However, this holds only at a certain distance and under static relations. If the temperature of the measurement object and thus that on the measuring coil changes other than the temperature of the sensor housing and thus that on the reference coil, this leads to (local) temperature gradients which disturb the symmetry and thus influence the measurement result. Likewise, mechanical extensions or compressions in the sensor element due to temperature changes result in non-deterministic and thus noncompensated movements or deformations of the sensor element, which likewise falsify the measurement.

The same holds for changes in humidity. Here as well, the differential approach only applies if both sensor pathways experience exactly the same change at the same time. This is not the case with the designs known in practice, since moisture usually acts only on the end-face measuring element, but not on the reference element integrated in the housing. The situation is similar with other perturbing factors, such as pressure and vibration.

Summarizing, the known sensors have the following problems: due to the design and the placement of the sensor element in a housing, perturbing factors on the one hand cause gradients which result in measurement errors. On the other hand, further measurement errors occur due to non-deterministic changes in the sensor element, caused by the perturbing factors or changes (aging) over the course of time.

Therefore, the problem which the invention proposes to solve is to avoid these drawbacks and to design and modify a sensor such that precise and stable measurements are possible. The same holds for the sensor element.

The above indicated problem is solved by the features of the coordinated claims 1 and 10. The sensor according to the invention is characterized in that the sensor element is constructed geometrically and/or electrically symmetrical in regard to its measuring elements and in that a mounting spaced apart from a holder is realized with the least possible contact surfaces on the sensor element. The sensor element according to the invention is designed accordingly.

The basis for this is a differential measurement system working by the capacitive or inductive principle. Differential here means first of all that the electrical arrangement already corresponds to a half-bridge or full-bridge arrangement. Thus, the problem is to also obtain a mechanically symmetrical arrangement, so that ambient factors such as temperature, pressure, moisture, etc., act symmetrically on the sensor element and do not falsify the measurement. Sensor element means in this context the essential element of a sensor or transducer, consisting of one or more measuring elements. In an inductive sensor, the sensor element is for example a coil with a central tap point, so that two partial coils are produced, serving as measuring elements. In the capacitive sensor, the sensor element consists of at least one measuring electrode and one reference electrode.

It is important that the sensor element has a symmetrical construction of the measuring elements and also in addition is symmetrically installed in the measurement arrangement.

The symmetrical construction of the sensor element can be achieved in that the measuring elements on both the front side and the back side of the sensor have the same distance from the housing surface. In the case of sensors where the measuring elements are embedded in a substrate consisting of multilayered circuit boards or multilayered ceramic (LTCC), this is achieved for example in that the layer makeup (number of layers and the position of the measuring elements) is chosen to be symmetrical. For example, 8 layers of substrate material would be used for a 7-layer coil.

It is advantageous for the substrate material to have the same thickness, so that the distance of the coil layers from the surface is the same in both directions. Thus, for example, a temperature change in the surroundings acts equally on both sides of the sensor element. At first, a local temperature gradient is established from the outside of the sensor element to the coils embedded in the interior. But since these are arranged at equal distances from the surface, the temperature change ultimately acts on the measuring elements in the same way. Thus, once again a symmetrical influencing is assured, and this is compensated by the differential evaluation. One could also arranged two measuring elements one above another, for example by integrating two 3-layer coils one on top of another in the multilayered substrate.

In the case of capacitive sensors, the measuring electrode is arranged near the end face in the first layer of the substrate. The reference electrode is arranged on the back side, away from the measurement object, in the last layer. In capacitive sensors a so-called shield is usually also employed, being maintained at the same potential as the measuring electrode, and shielding the measurement field against side influences. The arrangement of the shield electrodes (one each for the measuring electrode and the reference electrode) is likewise symmetrical. It is then further advantageous to introduce a grounding surface between the electrode arrangement of measuring and reference electrodes with corresponding shield electrodes. In this way, a symmetrical layout is achieved in regard to the arrangement of the electrodes in the substrate.

The measuring elements can also be arranged alongside each other. For example, multilayered coils can be arranged alongside each other in the mentioned ceramic substrate. In a rectangular substrate, one will arrange rectangular coils alongside each other. In a round substrate, the measuring elements could be distributed evenly over the circumference in the form of sectors, e.g., four partial coils in the form of four sectors. A nesting of the coils would also be conceivable, e.g., each layer of one coil is alternately coordinated with another partial coil. In this way, an especially uniform influencing of the partial coils could be achieved.

The measuring and reference electrodes could also be arranged alongside each other in capacitive sensors.

Usually the sensor element must be arranged on an object. However, a full-surface fastening to the object would defeat the symmetrical arrangement. If the sensor element or the coil arrangement which is embedded in a multilayered ceramic were to be fastened by its full surface to a holder, temperature changes would act more intensively or more delayed on the sensor element across the holder. For example, if the holder is heated intensively (because it fastens the sensor element to a machine part which is heated), the higher temperature will act at first on the back side of the sensor element. This produces a temperature gradient across the sensor element, which cannot be compensated by the differential arrangement of the measuring elements.

This can be accomplished in that the sensor element is also arranged almost symmetrical in regard to its holder. This is done with a pointlike attachment, e.g., a three-point bearing, which minimizes the bearing surface. For example, if balls are used for the three points, the bearing surface consists of only three point contacts. The heat input across such point contacts is greatly reduced, because the thermal mass is decoupled in this way. Thanks to the three-point bearing, the sensor element is almost free floating, so that ambient influences from all directions act equally and thus once more symmetrically on the (already symmetrically designed) sensor element. Thanks to a suitable choice of the balls, the heat transfer can be controlled. If the least possible heat transfer is desired, balls are used which are made from a material with slight heat transfer coefficient (such as Si3N4, Al2O3, ZrO2).

Besides the heat transfer, the coefficient of thermal expansion can also be controlled suitably by the ball material. Balls with low coefficient of thermal expansion alter the distance to the holder only slightly, while balls with higher coefficient of thermal expansion can achieve a temperature-dependent change in distance. Thus, a specific tilting could also be achieved with different ball material.

The choice of the ball material is also influenced by the measurement principle. For inductive or capacitive sensors it is advisable to use nonmetallic balls of ceramic or similar materials, since then an influencing of the measuring element is ruled out.

Instead of balls, tips or similar configurations with slight bearing surface could also be chosen. The deciding factor is the thermal decoupling from the substrate material, while at the same time exposing the sensor element to the surrounding atmosphere.

Thanks to an arrangement of the balls with one ball as a fixed bearing and two balls as loose bearings, a decoupling in the sideways direction from different expansion of sensor element and substrate material of the holder is additionally possible. This arrangement is also especially advantageous in regard to a replacement of the sensor element. If the sensor element needs to be replaced, the position of the replaced sensor element is clearly defined by the three-point arrangement. The fixed bearing, for example one in the form of a cup or a prism in which the first ball is situated, defines a fixed point. The second ball lies in a V-shaped groove, defining one degree of freedom in one direction. The third ball lies on a surface, so that there is an additional degree of freedom in a second direction. In this way, a relative lengthwise expansion between sensor element and holder due to different materials can be balanced out, without causing stresses in the sensor element. Furthermore, the need for an exact fit is reduced when replacing the sensor element, so that mechanical tolerances can also be balanced out during the replacement. The bearing surfaces (cup, groove, surface) can be as hard as possible, so that the balls are not pressed in and only a point contact is produced.

Thanks to the positioning of the bearing points relative to the sensor element and the suitable choice of the fixed point, the thermal expansion of the sensor element can be designed such that it is minimized relative to a particular position. For example, the fixed point will advantageously lie at the point of the measuring element which detects the measured quantity with the highest requirements.

As long as the sensor element is lying against the holder, gravity is sufficient for the stable fixation on the three-point bearing. In other installation situations, the sensor element must be pressed against the balls. This is done, for example, by means of a spring, which produces an adjustable force and presses the sensor element against the balls and holder.

In order to avoid an influencing of the measurement in the case of field-bound sensors, it is advisable to make the spring and the fastening element from nonmetallic material. For example, a plastic spring can be used, which is pretensioned with a plastic screw. Other nonmetallic materials are also conceivable, such as ceramic. The installation of the spring is advisedly done inside the three bearing points of the balls, for example, at the center of gravity of the triangle. The force and the holding of the spring and the fastening element must be designed such that the movement of the sensor element is not restricted by thermal expansions.

Now, there are various ways of embodying and modifying the teaching of the present invention in advantageous manner. For this, refer on the one hand to the claims coordinated with claim 1 and on the other hand to the following explanation of preferred embodiments of the invention with the aid of the drawings. Generally preferred embodiments and modifications of the teaching will also be explained in connection with the explanation of the preferred embodiments of the invention with the aid of the drawings. The drawing shows

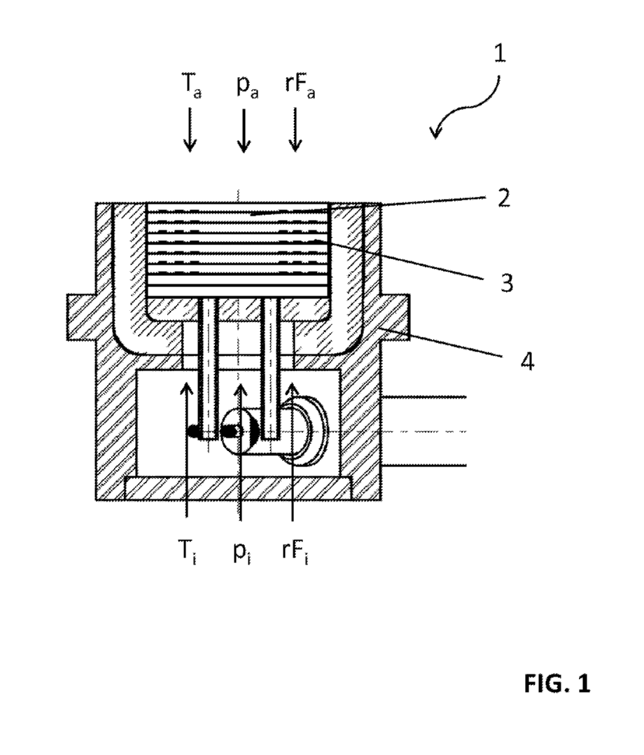

FIG. 1 in a schematic side view, sectioned, the basic layout of a sensor of this kind belonging to the prior art,

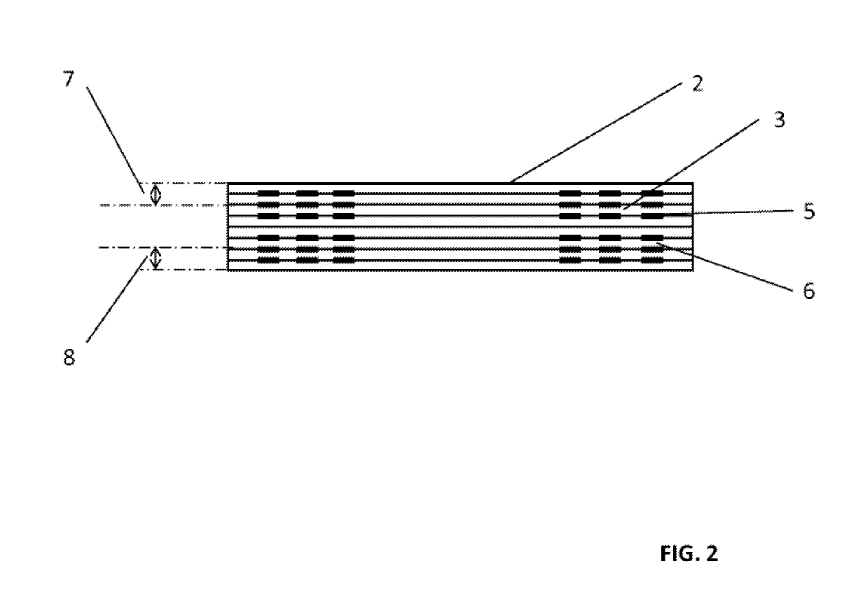

FIG. 2 in a schematic view, a sample embodiment of a sensor element according to the invention in which a multilayered coil comprises two partial coils,

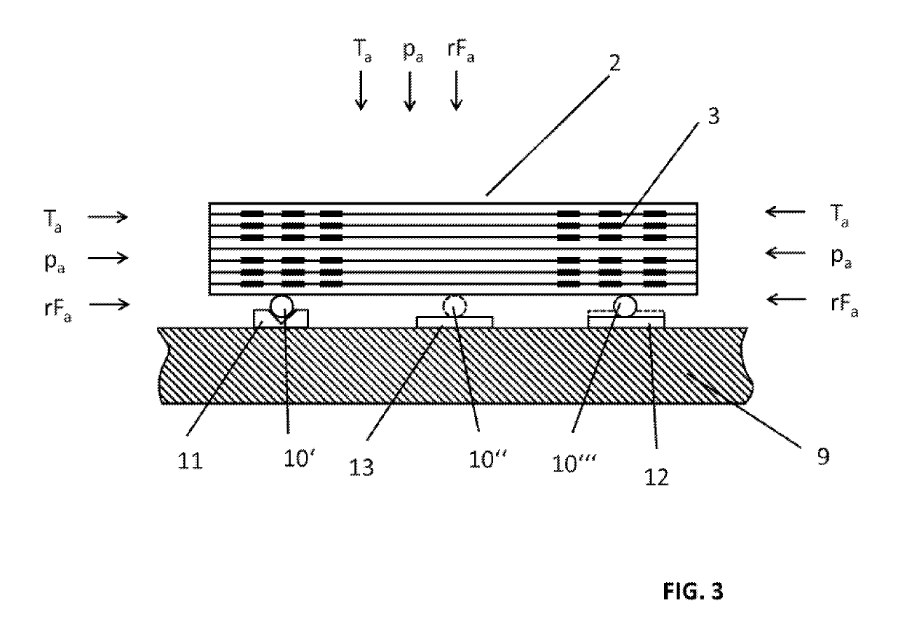

FIG. 3 in a schematic view, a sensor with a sensor element per FIG. 2, wherein the sensor element is mounted by a three-point bearing on a holder,

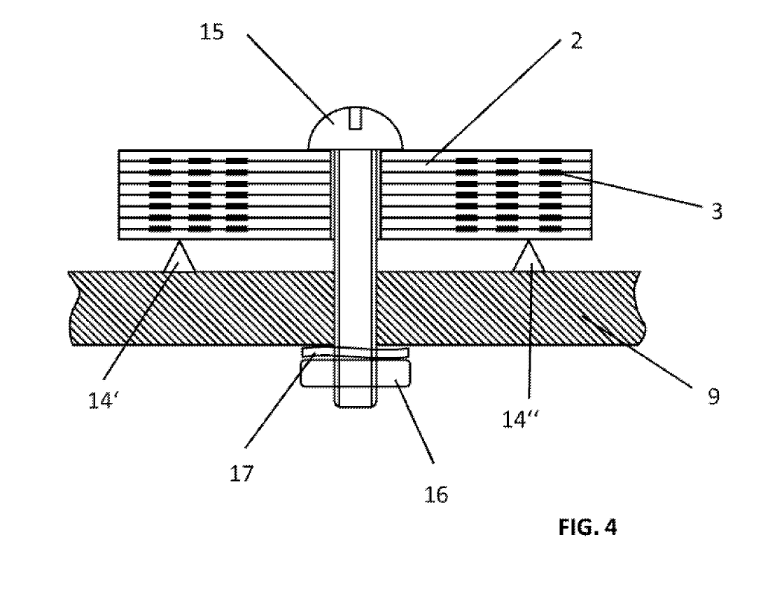

FIG. 4 in a schematic view, another sample embodiment of a sensor according to the invention with a sensor element similar to that of FIG. 2, wherein the sensor element is mounted by three point bearings on the holder,

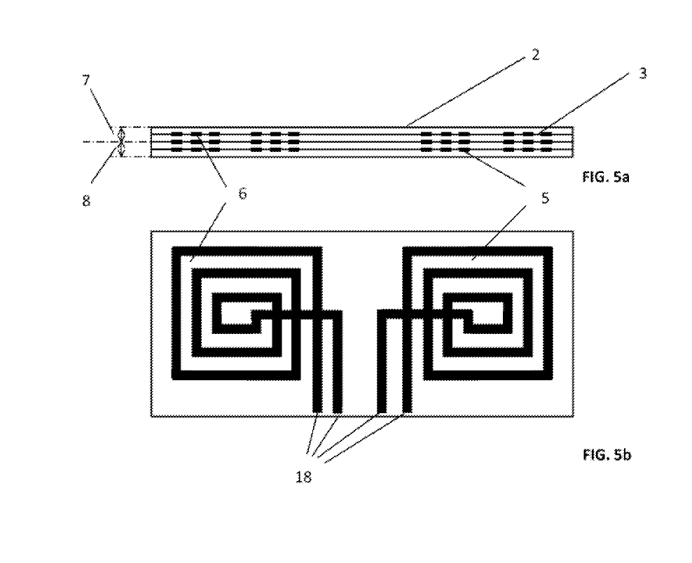

FIG. 5a in a schematic view, a sensor element according to the invention with multilayered coil comprising two partial coils,

FIG. 5b in a schematic top view, the object from FIG. 5a, wherein the winding turns situated in different layers are represented as a projection,

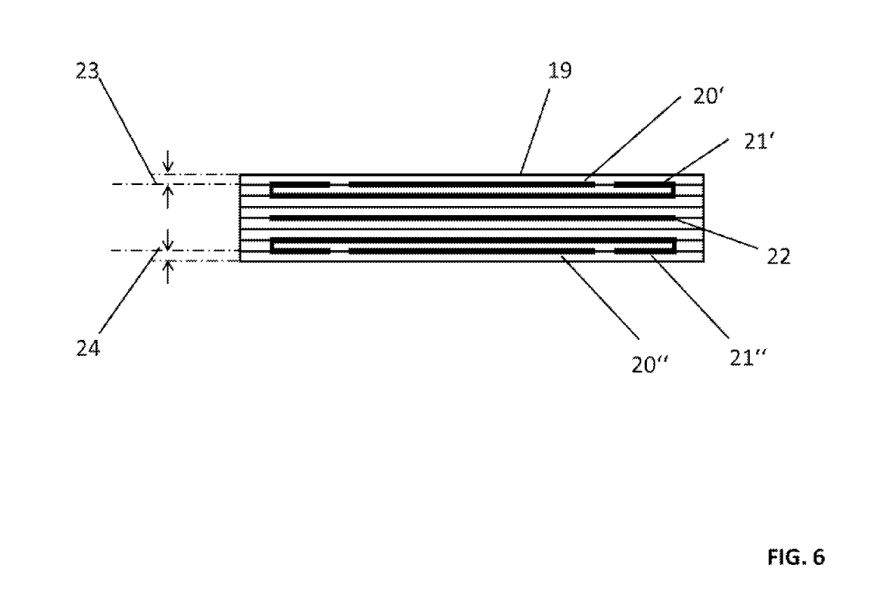

FIG. 6 in a schematic view, another sample embodiment of a sensor element according to the invention in which integrated electrodes make possible a capacitive measurement, and

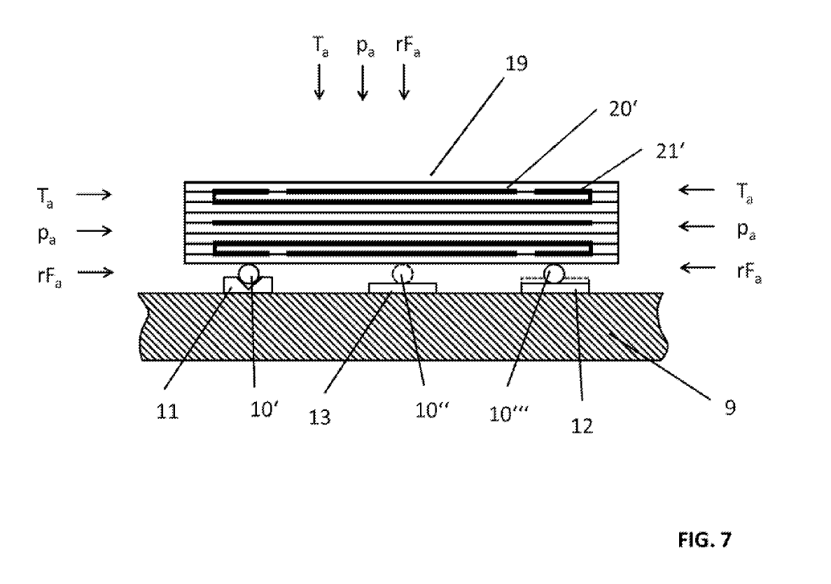

FIG. 7 in a schematic view, a sensor with a sensor element per FIG. 6, wherein the sensor element is mounted by balls at three points on the bearing base.

FIG. 1 shows a conventional inductive displacement sensor (1) of the prior art. The sensor element (2) of multilayered ceramic contains a multilayered coil (3), which is installed in a housing (4). The external ambient influences such as temperature Tₐ, pressure pₐ and relative humidity rFₐ differ from the internal states Tᵢ, pᵢ and rFᵢ. The sensor element (2) is acted upon by different influences, resulting in an asymmetry (gradients).

FIG. 2 shows in a sectional representation a symmetrical sensor element (2) with a multilayered coil (3). The coil consists of two partial coils (5 and 6), which are arranged symmetrical to each other and one on top of the other. The partial coils are symmetrical in construction inside the sensor element, i.e., the distance from the midpoint of the coil to the front (7) and to the back (8) of the sensor element is the same. Each partial coil (5, 6) consists of three winding turns per layer, arranged in three layers.

FIG. 3 shows the symmetrical sensor element (2), which lies against a holder (9). The bearing base is created by three balls (10′, 10″ and 10′″) and thus consists of only three points. The balls lie in the holder in a prism (11), a groove (12) and against a surface (13). Thus, the prism defines a fixed point (fixed bearing). Starting from the fixed point, the sensor element can move in a direction along the groove (12) and at the same time in the other direction on the surface (13) relative to the holder, e.g., due to thermal expansion. Thanks to the decoupling from the holder, ambient influences such as temperature Tₐ, pressure pₐ and relative humidity rFₐ can act from all sides at the same time and symmetrically on the sensor element. For clarity of representation, an element holding the arrangement together and possibly restoring the sensor element in its movement such as a spring element is not shown.

FIG. 4 shows, in place of balls, three tips (14′, 14″, 14′″) as pointlike bearing points. The sensor element is fastened by a plastic screw (15) with nut (16) on the holder (9). The spring is a corrugated washer (17). The third tip (14′″) is not shown.

FIG. 5 shows in the top half in sectional representation a symmetrical sensor element (2) with a multilayered coil (3). The coil consists of two partial coils (5 and 6), which are arranged symmetrical to each other and alongside each other. The partial coils are symmetrical in design inside the sensor element, i.e., the distance from the midpoint of the coil to the front (7) and to the back (8) of the sensor element is identical. Each partial coil (5,6) consists of three winding turns per layer, which are arranged in three layers. In the bottom half is shown the sensor element in top view, representing the winding turns situated in the different layers as a projection. The necessary through contacts are not shown. The individual tap points (18) of the partial coils are led individually to the outside, so that the coils can be suitably interconnected with each other.

FIG. 6 shows a capacitive sensor element (19) with a measuring electrode (20′) and the accompanying reference electrode (20″). Both electrodes are shielded by a shield electrode (21′, 21″) against influences from the side and from the rear. In addition, a grounding surface (22) is additionally introduced into the substrate between the electrode arrangement the electrode arrangement is arranged symmetrical to the top and bottom side, so that the distance (23,44) from the surface is identical.

FIG. 7 shows a capacitive sensor element with three-point bearing similar to FIGS. 5a and 5b.

In regard to further advantageous embodiments of the teaching of the invention, in order to avoid repetition, reference is made to the general portion of the specification and the accompanying claims.

Finally, it is expressly pointed out that the above described sample embodiments of the teaching of the invention serve only to explain the teaching claimed, but do not limit it to the sample embodiments.

### LIST OF REFERENCE NUMBERS

1 Displacement sensor
2 Sensor element
3 Coil
4 Housing
5 Partial coil
6 Partial coil
7 Distance to front of the sensor element
8 Distance to back of the sensor element
9 Holder
10′, 10″, 10′″ Ball
11 Prism
12 Groove
13 Surface
14′, 14″, 14′″ Tip
15 Plastic screw
16 Nut
17 Corrugated washer
18 Tap point
19 Capacitive sensor element
20′ Measuring electrode
20″ Reference electrode
21′, 21″ Shield electrode
22 Measuring surface
23 Distance to front of the sensor element
24 Distance to back of the sensor element

1. A non-contact working sensor, especially an inductive or capacitive sensor, preferably for measuring the distance or position of an object, with an inductive or capacitive sensor element, wherein measuring elements of the sensor element are embedded in a multilayered ceramic and together with the ceramic form the sensor element, characterized in that the sensor element is constructed geometrically and/or electrically symmetrical in regard to its measuring elements and in that a mounting spaced apart from a holder is realized with the least possible contact surfaces on the sensor element.

2. The sensor as claimed in claim 1, characterized in that the sensor element is capacitive, wherein the measuring elements are designed as electrodes, wherein the electrodes are embedded in the multilayered substrate and wherein the electrode arrangement is arranged and designed preferably symmetrical to the top and/or bottom of the sensor element.

3. The sensor as claimed in claim 1, characterized in that the sensor element is inductive, wherein the measuring elements are designed as a coil or coils, wherein the coil or coils are embedded in the multilayered substrate and wherein the coil comprises two partial coils, which are arranged and/or designed symmetrical to each other.

4. The sensor as claimed in claim 3, characterized in that the partial coils are arranged symmetrical alongside each other or symmetrical on top of one another or symmetrical inside each other or symmetrical nested in one another.

5. The sensor as claimed in claim 3, or characterized in that the partial coils are designed such that the distance from the midpoint of the coil to the front and to the back of the sensor element is substantially the same.

6. The sensor as claimed in claim 1, characterized in that the sensor element is mounted on the holder by a linear bearing with two or more bearing lines or by a point bearing with three or more bearing points.

7. The sensor as claimed in claim 6, characterized in that the mounting of the sensor element on the holder is defined by two or three rolls or rollers or by preferably three balls.

8. The sensor as claimed in claim 7, characterized in that the balls lie in a prism, a groove or slot and on a surface, wherein the prism defines a fixed point in the sense of a fixed bearing.

9. The sensor as claimed in claim 6, characterized in that the mounting is defined by preferably three balls, pyramids, etc., fastened to the holder, with end tips which form the bearing points for the sensor element.

10. A sensor element with features according to claim 1, for application or use in a noncontact working sensor.

11. A sensor element with features according to claim 1, characterized in that the substrate is a multilayered circuit board.

12. A sensor element with features according to claim 1, characterized in that the substrate is a multilayered ceramic.
